(19) United States
(12) Patent Application Publication
(10) Pub. No.: US 2004/0265566 A1
(43) Pub. Date: Dec. 30, 2004

(54) Interior trim system and method for making same

(75) Inventor: Barry R. Wyerman, Novi, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI

(21) Appl. No.: 10/610,380

(22) Filed: Jun. 30, 2003

(51) Int. Cl. D03D 15/00; B60J 7/00; B32B 3/26; B32B 3/00; B29C 65/00; B32B 5/22; B60R 13/07; B62D 25/07; B62D 25/06; B32B 27/00

(52) U.S. Cl. 428/317.9; 428/424.8; 428/425.1; 428/304.4; 428/316.6; 296/214; 156/304.6; 428/315.9; 428/158

(57) ABSTRACT

A method of making an interior trim system for a vehicle includes providing a trim assembly having a cover layer and a backing layer attached to the cover layer, the backing layer including a polymeric material and a blowing agent. The method further includes activating the blowing agent to form fluid cells in the backing layer that expand and burst, such that the backing layer is an air-permeable layer after the activating step.

### BACKGROUND OF THE INVENTION

1. Field of the Invention

The invention relates to an interior trim system for use with a motor vehicle, and to a method of making the trim system.

2. Background Art

A known method of making an interior trim system, such as a flooring system, involves applying an air-impermeable polyethylene backing layer onto a carpet layer including tufted fibers woven into a spun bond polyester backing. The polyethylene backing layer binds the fibers to the polyester backing, thereby improving durability of the flooring system.

One known method of making an air-permeable flooring system includes applying a latex coating onto a back surface of a carpet layer. The latex coating wicks into the back surface of the carpet layer, thereby creating an air-permeable coating on the carpet layer. A disadvantage of this method, however, is that material and equipment costs are significant.

### SUMMARY OF THE INVENTION

Under the invention, a method of making an interior trim system for a vehicle includes providing a trim assembly having a cover layer and a backing layer attached to the cover layer, the backing layer including a polymeric material and a blowing agent; and activating the blowing agent to form fluid cells in the backing layer that expand and burst, such that the backing layer is an air-permeable layer after the activating step. With such a method, the backing layer may be initially formed as an air-impermeable layer that is transformed or converted into an air-permeable layer without mechanical means.

Further under the invention, a method of making a cover layer assembly for a vehicle includes applying a backing layer to a cover layer, the backing layer including a polymeric material and an activatable blowing agent. Upon activation, the blowing agent is configured to form fluid cells in the backing layer that expand and burst, such that the backing is air-permeable after activation of the blowing agent.

Still further under the invention, an interior trim system for a vehicle includes a cover layer and an air permeable backing layer attached to the cover layer. The backing layer comprises a polymeric material and has multiple pores extending therethrough, the pores being formed through activation of a blowing agent of the backing layer.

Still further under the invention, a cover layer assembly for use in making an interior trim system for a vehicle includes an air-permeable cover layer and a backing layer attached to the cover layer. The backing layer comprises a polymeric material and an activatable blowing agent. Upon activation, the blowing agent is configured to form fluid cells in the backing layer that expand and burst, such that the backing layer is air-permeable after activation of the blowing agent.

While exemplary products and method of making the products in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a schematic cross-sectional view of an interior trim system in accordance with the invention, the trim system including a cover layer, an air-permeable backing layer attached to the cover layer, and a padding layer attached to the backing layer;

FIG. 2 is a schematic view of an arrangement for making the trim system in accordance with the invention; and

FIG. 3 is a schematic cross-sectional view of the cover layer and backing layer, which includes a blowing agent, wherein the backing layer is shown as an air-impermeable layer before activation of the blowing agent.

### DETAILED DESCRIPTION OF THE PREFERRED EMBODIMENT(S)

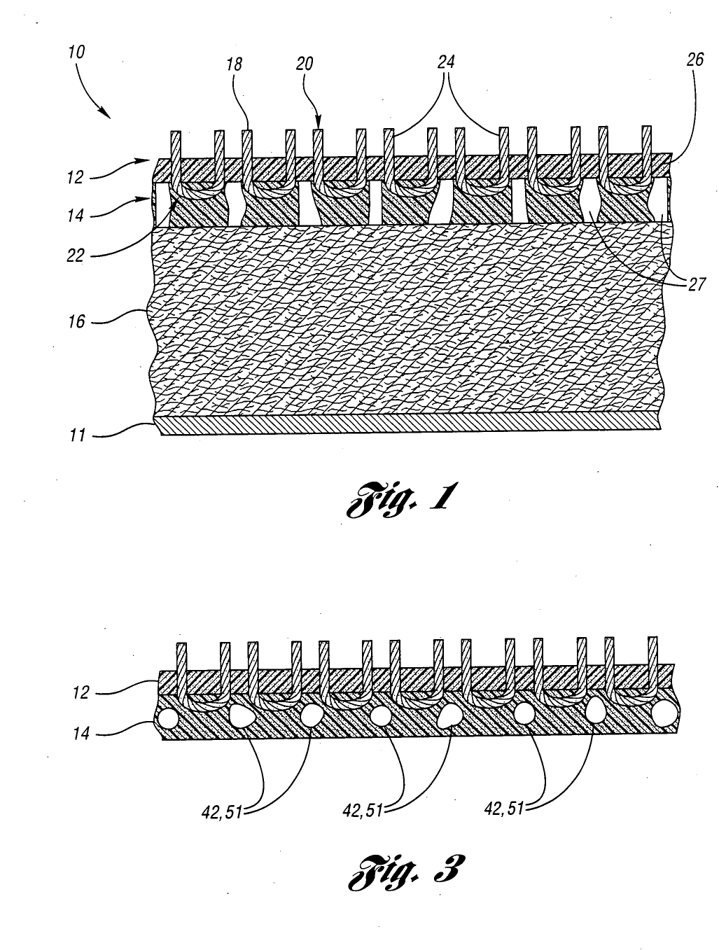

FIG. 1 shows an interior trim system 10, such as a flooring system or carpet system, that is positionable adjacent to a vehicle part 11, such as a floor pan, of a motor vehicle. As additional examples, trim system 10 may be a headliner, package shelf, package shelf covering, door panel, door panel covering, or other covering or lining system for use with the vehicle.

The trim system 10 includes a cover layer 12 and an air-permeable backing layer 14 attached to the cover layer 12. In the embodiment shown in FIG. 1, the trim system 10 also includes an air-permeable padding layer 16 attached to the backing layer 14.

While the cover layer 12 may comprise any suitable layer or layers, in the embodiment shown in FIG. 1, the cover layer 12 includes an air-permeable carpet layer 18 having an appearance surface 20 that faces toward a vehicle interior, and a concealable back surface 22. In the embodiment shown in FIG. 1, the carpet layer 18 includes natural and/or synthetic fibers 24, such as tufted nylon fibers, that may be woven into, or otherwise connected to, a backing 26, such as a porous, spun bond polyester backing. As another example, carpet layer 18 may include non-woven fibers provided with or without a backing.

The backing layer 14 includes a polymeric material that is formed as an air-permeable layer, as described below in detail. In the embodiment shown in FIG. 1, for example, the backing layer 14 is made of polyethylene and includes multiple voids or pores 27 that extend through the entire thickness of the backing layer 14. While the backing layer 14 may have any suitable thickness, in one embodiment of the invention, the backing layer 14 has a thickness in the range of one to three millimeters.

The pores 27 shown in FIG. 1 have different sizes and shapes, and are spaced at varying distances. Alternatively, the pores 27 may be similar in size and shape, and may be spaced generally evenly apart.

The padding layer 16 may be attached to the backing layer 14 in any suitable manner, such as with an adhesive. Furthermore, the padding layer 16 may comprise any suitable material including foam and/or fibers, such as natural and/or synthetic fibers. In the embodiment shown in FIG. 1, the padding layer 16 is a lightweight, porous layer that comprises synthetic fibers, such as polyethylene terephthalate fibers, and/or cotton fibers mixed with binder fibers.

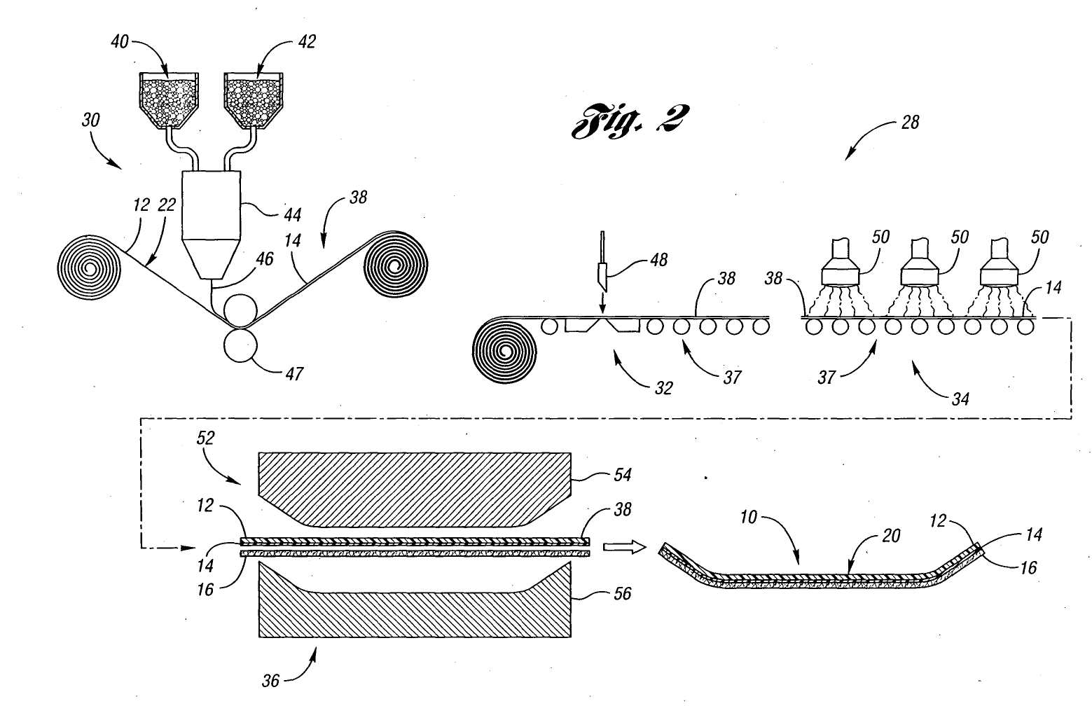

Referring to FIG. 2, a method according to the invention for making the trim system 10 will now be described. While the trim system 10 may be manufactured using any suitable system, FIG. 2 shows an exemplary system or arrangement, such as production line arrangement 28, for manufacturing trim system 10. Production line arrangement 28 includes a backing layer application station 30, a cutting station 32, an activation station 34, and a molding station 36. The stations 30-36 may all be disposed at the same location or at different locations. For example, the application station 30 may be disposed at a first location, and the remaining stations 32-36 may be disposed at a second location. Furthermore, the production line arrangement 28 may include one or more conveyor systems 37 for transporting components within and/or between the stations 32-36.

At the backing layer application station 30, backing layer 14 is applied to the cover layer 12 to form a trim or cover layer assembly 38, such as a carpet assembly. In the embodiment shown in FIG. 2, polymeric particles, such as polyethylene pellets 40, are mixed and heated with an activatable blowing agent 42 in an extruder 44 to form a heated mixture. The heated mixture is then extruded by the extruder 44 to form a film 46 that is applied on the back surface 22 of the cover layer 12. In the embodiment shown in FIG. 2, the film 46 and the cover layer 12 are pressed between rollers 47, such that the film 46 forms the backing layer 14 as an air-impermeable layer.

As explained below, the blowing agent 42 is configured to outgas upon activation to thereby form fluid cells, such as air cells, in the backing layer 14 that expand and burst. Examples of suitable blowing agents include medium temperature endothermic blowing agents, such as HYDROCEROL™ available from Clariant of Winchester, Va. Furthermore, the blowing agent 42 may have any suitable configuration, such as particles or granules.

The cover layer assembly 38 may then be rolled into a roll that is transported to the cutting station 32. At cutting station 32, cover layer assembly 38 may be cut into a desired size and shape for a particular application or for further processing. For example, cutting station 32 may include one or more cutting apparatuses 48, such as a cutting blade or water jet, for cutting the cover layer assembly 38. Alternatively, the cutting step may be omitted if not required.

Next, referring to FIGS. 1-3, the cover layer assembly 38 is transferred to activation station 34, shown in FIG. 2, where the blowing agent 42 may be activated by one or more activators 50 to form pores 27 in the backing layer 14, as shown in FIG. 1, to thereby transform the backing layer 14 into an air-permeable layer. For example, if the blowing agent 42 is heat-activatable, one or more activators 50 may be configured as heaters, such as hot air, electric, or electromagnetic wave heaters, including microwave, infrared, and/or selective wavelength heaters, that are configured to heat the backing layer 14 to or above an activation temperature, which is preferably above the extrusion temperature at the extruder 44. While the activation temperature may be any suitable temperature, in one embodiment of the invention, the activation temperature may be in the range of 170 to 185° C., and more particularly approximately 175° C. At or above the activation temperature, blowing agent particles, such as blowing agent granules 51 shown in FIG. 3, may outgas and form fluid cells, such as air cells, in the backing layer 14 that expand and burst to form the pores 27, shown in FIG. 1. In one embodiment of the invention, the granules 51 have different sizes and shapes, and upon activation, each granule 51 forms a pore 27 that extends the entire thickness of the backing layer 14. In another embodiment, the granules 51 may be similar in size and shape, and may be spaced generally evenly apart.

Alternatively, one or more activators 50 may be configured as an oven for heating backing layer 14 to activate the blowing agent 42. As another example, if the blowing agent 42 is light-activatable, one or more activators 50 may be configured as ultraviolet light sources, such as lamps, that expose the backing layer 14 to ultraviolet light to activate the blowing agent 42. Still further, one or more activators 50 may be configured as a laser light source for activating the blowing agent 42. As yet another example, one or more activators 50 may be configured to apply an activation agent, such as a catalyst or reactive agent, on the backing layer 14 to activate the blowing agent 42, or to facilitate or accelerate activation by another means. For example, one or more activators 50 may apply a material, such as carbon black, on the backing layer 14 such that the backing layer 14 more readily absorbs electromagnetic radiation introduced by one or more other applicators 50.

Once activated in any manner, the blowing agent 42 may be configured to form fluid cells that expand and burst to form the pores 27. After the activation step, however, some portion or amount of the blowing agent 42 may remain un-activated.

Next, referring to FIG. 2, the cover layer assembly 38 with air-permeable backing layer 14 may be transferred to molding station 36 where the cover layer assembly 38 may be molded into a desired shape to form the trim assembly 10. In the embodiment shown in FIG. 2, molding station 36 includes a mold 52 having first and second mold sections 54 and 56, respectively, that each have a non-planar mold surface. The mold 52 is movable between an open position, shown in FIG. 2, and a closed position (not shown) for compressing and shaping the cover layer assembly 38 into a three dimensional molded shape. Alternatively, one or both mold sections 54 and 56 may have a planar mold surface.

One or more additional layers, such as padding layer 16, may also be positioned between the mold sections 54 and 56, such that the additional layers may be molded with and attached to the cover layer assembly 38. For example, padding layer 16 and/or other layers may be attached to the cover layer assembly 38 during the molding process, such as with an adhesive. Alternatively, the padding layer 16 and/or other additional layers may be attached to the cover layer assembly 38 prior to positioning the cover layer assembly 38 between the mold sections 54 and 56.

In the embodiment shown in FIG. 2, the padding layer 16 has a planar configuration when initially positioned between the mold sections 54 and 56. Alternatively, the padding layer 16 and/or other additional layers may be molded in a separate molding operation such that each of the additional layers has a three dimensional molded shape, such as a shape corresponding to the mold surfaces of mold sections 54 and 56, prior to positioning such layer or layers between the mold sections 54 and 56.

If additional heating is required prior to molding the cover layer assembly 38 and any additional layers, such as padding layer 16, in the mold 52, the cover layer assembly 38 and/or any additional layers may be preheated in an oven, or by any other suitable means. Furthermore, one or both mold sections 54 and 56 may be cooled to facilitate molding of the cover assembly 38 and any additional layers.

Although the activation station 34 and molding station 36 are shown as separate stations in FIG. 2, the molding station 36 may be configured to activate the blowing agent 42 in addition to shaping the cover assembly 38. For example, if the blowing agent 42 is light activatable, one or both mold sections 54 and 56 may include one or more ultraviolet light sources that expose the backing layer 14 to ultraviolet light to activate the blowing agent 42. As another example, the mold 52 may be configured to spray or otherwise introduce an activation agent on the backing layer 14 for activating the blowing agent 42.

As another alternative, the blowing agent 42 may be activated at the same time the backing layer 14 is applied to the cover layer 12. For example, one or more activators 50 may be disposed at the backing layer application station 30, such that the blowing agent 42 may be heated, or otherwise activated, while the backing layer 14 is being applied to the cover layer 12, or immediately after application of the backing layer 14. As another example, if the blowing agent 42 is heat-activatable, the film 46 may be extruded at an extrusion temperature that is above the activation temperature of the blowing agent 42, such that the backing layer 14 is formed as an air-permeable layer on the cover layer 12. For instance, the film 46 may be extruded at a temperature in the range of 200 to 225° C.

Under the invention, the entire trim system 10 may be formed as an air-permeable system. For example, trim system 10 may be formed as an air-permeable flooring system or carpet system that is configured to maximize sound absorption. While each layer of the trim system 10 may have any suitable air-permeability, in one embodiment of the invention, the cover layer 12 has an airflow resistance in the range of 0 to 500 mks Rayls, the backing layer 14 has an airflow resistance in the range of 2,500 to 10,000 mks Rayls, the padding layer 16 has an airflow resistance in the range of 0 to 500 mks Rayls, and the entire trim system has an airflow resistance in the range of 2,500 to 10,000 mks Rayls. Alternatively, trim system 10 may include one or more air-impermeable layers attached to air-permeable backing layer 14 or other component of trim system 10. With any of the above configurations, the backing layer 14 may be initially formed as an air-impermeable layer that is transformed or converted into an air-permeable layer by the method described above in detail.

Furthermore, the air-permeability of the backing layer 14 may be controlled by controlling the amount of blowing agent added to the backing layer 14 and/or the degree of activation of the blowing agent. As a result, the backing layer 14 may be formed to have any suitable airflow resistance.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of making an interior trim system for a vehicle, the method comprising:
providing a trim assembly having a cover layer and a backing layer attached to the cover layer, the backing layer including a polymeric material and a blowing agent; and
activating the blowing agent to form fluid cells in the backing layer that expand and burst, such that the backing layer is an air-permeable layer after the activating step.

2. The method of claim 1 wherein, prior to the activating step, the backing layer is an air-impermeable layer.

3. The method of claim 1 wherein the polymeric material includes polyethylene.

4. The method of claim 1 wherein the activating step includes heating the backing layer.

5. The method of claim 1 wherein the activating step includes introducing a reactive agent on the backing layer.

6. The method of claim 1 further comprising attaching a porous padding layer to the backing layer.

7. A method of making a cover layer assembly for a vehicle, the method comprising:
applying a backing layer to a cover layer, the backing layer including a polymeric material and an activatable blowing agent, wherein upon activation, the blowing agent is configured to form fluid cells in the backing layer that expand and burst, such that the backing is air-permeable after activation of the blowing agent.

8. The method of claim 7 wherein the polymeric material includes polyethylene.

9. The method of claim 7 wherein the cover layer includes fibers.

10. The method of claim 7 wherein the applying step comprises heating a mixture of polyethylene pellets and the blowing agent to form a heated mixture, extruding the mixture to form a film, and applying the film on a back surface of the cover layer, the film defining the backing layer.

11. The method of claim 10 wherein the blowing agent is activatable when heated above an activation temperature, and wherein the step of heating a mixture of polyethylene pellets and the blowing agent is performed such that the heated mixture is heated to a temperature above the activation temperature.

12. The method of claim 7 further comprising activating the blowing agent such that the backing layer is air-permeable after the activating step.

13. The method of claim 12 wherein the activating step is performed after the applying step.

14. The method of claim 13 wherein the applying step is performed such that the backing layer is an air-impermeable layer prior to the activating step.

15. The method of claim 12 wherein the activating step and the applying step are performed simultaneously.

16. The method of claim 12 wherein the activating step includes heating the backing layer.

17. The method of claim 12 wherein the activating step includes introducing an activation agent on the backing layer.

18. The method of claim 12 wherein the activating step includes exposing the backing layer to ultraviolet light.

19. The method of claim 12 further comprising attaching a porous padding layer to the backing layer.

20. An interior trim system for a vehicle, the system comprising:
a cover layer; and
an air permeable backing layer attached to the cover layer, the backing layer comprising a polymeric material and having multiple pores extending therethrough, the pores being formed through activation of a blowing agent of the backing layer.

21. The trim system of claim 20 wherein the polymeric material comprises polyethylene.

22. The trim system of claim 20 wherein the pores have different sizes and shapes.

23. The trim system of claim 20 wherein the cover layer comprises fibers and has an appearance surface that is adapted to face toward an interior compartment of the vehicle.

24. The trim system of claim 20 further comprising a porous padding layer attached to the backing layer such that the backing layer is disposed between the cover layer and the padding layer.

25. A cover layer assembly for use in making an interior trim system for a vehicle, the assembly comprising:
an air-permeable cover layer; and
a backing layer attached to the cover layer, the backing layer comprising a polymeric material and an activatable blowing agent, wherein upon activation, the blowing agent is configured to form fluid cells in the backing layer that expand and burst, such that the backing layer is air-permeable after activation of the blowing agent.

26. The cover layer assembly of claim 25 wherein the backing layer is air-impermeable prior to activation of the blowing agent.

27. The assembly of claim 25 wherein the blowing agent is heat-activatable.

28. The assembly of claim 25 wherein the blowing agent is light-activatable.

29. The assembly of claim 25 wherein the polymeric material comprises polyethylene.

30. The assembly of claim 25 wherein the cover layer comprises fibers.
